(19) United States
(12) Patent Application Publication
(10) Pub. No.: US 2005/0047412 A1
(43) Pub. Date: Mar. 3, 2005

(54) Establishment and enforcement of policies in packet-switched networks

(76) Inventor: Susan Hares, Saline, MI (US)

Correspondence Address: PERKINS COIE LLP, P.O. BOX 2168, MENLO PARK, CA, 94026, US

(21) Appl. No.: 10/648,141

(22) Filed: Aug. 25, 2003

(51) Int. Cl. H04L 12/28

(52) U.S. Cl. 370/392; 709/220; 709/238

(57) ABSTRACT

Policy domains are introduced, which include methods and algorithms for ensuring policy consistency within defined regions of one or more communications networks. Examples of such policies include network functions such as routing, filtering, security, authentication, information summarization and expansion. These policies may be organized into hierarchies of policy categories. The policy domains include mechanisms for adding and deleting policies while preserving consistency, as well a mechanisms for allowing fast synchronization and convergence of policies between local databases resident different nodes/peers in the networks. Policy domains may be delineated by pre-existing logical topologies, such as autonomous systems, or may have evolving boundaries.

### CROSS-REFERENCE TO RELATED APPLICATION(S)

This application is related to U.S. Provisional Application No. 60/390,576, entitled “Fibonacci Heap for Use with Internet Routing Protocols,” U.S. Utility Application entitled “Fibonacci Heap for Use with Internet Routing Protocols,” U.S. Utility Application entitled “Systems and Methods for Routing Employing Link State and Path Vector Techniques,” filed on the same day herewith, and U.S. Utility Application entitled “Nested Components for Network Protocols,” also filed on the same day herewith, each of which is hereby incorporated by reference in its entirety.

### TECHNICAL FIELD

This application relates to the field of communications networks, and more particularly, to protocols and algorithms deployed in packet-switched networks.

### BACKGROUND

In communications networks such as the Internet, information is transmitted in the form of packets. A packet comprises a unit of digital information that is individually routed hop-by-hop from a source to destination. The routing of a packet entails that each node, or router, along a path traversed by the packet examines header information in the packet, to compare this header against a local database; upon consulting the local database, the router forwards the packet to an appropriate next hop. The local database is typically referred to as the Forwarding Information Base or FIB; the FIB is typically structured as a table, but may be instantiated in alternative formats. Entries in the FIB determine the next hop for the packet, i.e., the next router, or node, to which the respective packets are forwarded in order to reach the appropriate destination. The Forwarding information Bases are usually derived from global or network-wide information from a collective database. Each protocol names the collective databases to denote the type of information. Such databases are referred to generically herein as Network Information Databases (NIBs).

In implementations of the Internet Protocol (IP), the FIB is typically derived from a collective database, i.e., a NIB, referred to as a Routing Information Database or RIB. A RIB resident on a router amalgamates the routing information available to that router; one or more algorithms are typically used to map the entries, e.g., routes, in the RIB to those in the FIB, which, in turn, is used for forwarding packets to their next hop. The IP RIB may be constructed by use of two techniques, which may be used in conjunction: (a) static configuration and (b) dynamic routing protocols. Dynamic IP routing protocols may be further subdivided into two groups based on the part of the Internet in which they operate: exterior gateway protocols, or EGPs, are responsible for the dissemination of routing data between autonomous administrative domains, and interior gateway protocols, or IGPs, are responsible for dissemination of routing data within a single autonomous domain. Furthermore, two types of IGPs are in widespread use today: those that use a distance-vector type of algorithm and those that use the link-state method.

Routers typically support route selection policies which enable the selection of a best route amongst alternative paths to a destination. Routing selection policies may be pre-defined by a protocol, or distributed statically or dynamically distributed. EGP protocols such as Border Gateway Protocol Version 4 (BGP-4) allow route selection policy on destination address and the BGP Path information. Routers also typically support route distribution policies, which govern the determination of which routes are sent to particular peers. Route distribution policies can be pre-defined by a protocol, statically configured or dynamically learned. Dynamically learned policies can, in turn, be forwarded to a router within the same routing protocol that sends routes, or may be sent in a separate protocol. As illustrative examples, BGP-4 allows for the inclusion of outbound route filter policies within BGP packets; the Route Policy Server Language sends route distribution policy in a separate protocol. Some BGP-4 peers add or subtract BGP communities from BGP-4 path attributes, to mitigate policy processing on recipient peers. The addition of the BGP-4 Communities is sometimes called coloring or “dyeing” BGP-4 routes.

Routing protocols frequently secure data by use of security information, which may be statically configured or dynamically distributed. In the latter case, security often flows down a hierarchy of trust. A common trusted source originates certificates, which are passed down to a set of trusted devices; these trusted devices in turn pass down this “trust” model to other devices. This model of trust flow is referred to as security delegation. Public Key Infrastructure includes certificates are passed down a security delegation chain to given nodes, in conformance with the security delegation model. Secure BGP (S-BGP) utilizes such certificates to attest that BGP route information has been certified as correct.

Policies may be loaded on individual routers via local static configuration or over an attached network. Manual configuration of policies on routers increases the likelihood of erroneous entries. Additionally, given the considerable number of nodes in communication over inter-networks, manual configuration suffers from obvious problems of scale and consistency. Dynamic configuration takes considerable time and system resources in ensuring consistency preservation, thereby delaying network convergence.

As illustrative examples of the complications inherent in preserving network consistency, consider common policy filters, such as firewalls and BGP routers. Firewalls may have up to contain from 10 to 100,000 filters for different types of information. BGP peers route 140,000 routes and may also have from 10 to 100,000 filters determining acceptable routes. A filter description that is encoded as an ASCII string for a command line interface may, in turn, consume 100-1000 bytes of data, as well as several seconds of interchange in order to change the filter. Despite the enormous amounts of traffic required to communicate these filters, this problem is dwarfed by the challenge of reducing the time required to change filters while preserving consistency.

In view of the issues raised above, there is a need for novel techniques for ensuring consistency amongst policies amongst communications nodes. Such techniques should ensure fast, efficient convergence of network policies. Furthermore, such consistency should be accomplished while allowing policies and network regions to be updated dynamically, and in a manner which assures the security of the network. These and other objects are addressed herein.

### SUMMARY

The invention includes methods and architectures for the enforcement of consistent policy across defined portions of one or more packet-switched networks. The invention enables nodes contained in these network regions to communicate and enforce policies that govern their operation. Illustrative examples of such policies include network functions such as routing, filtering, security, authentication, information summarization and expansion; these and other categories of network policy are elaborated upon further herein.

Embodiments of the invention include a feature referred to herein as a Policy Domain. The policy domain includes mechanisms for ensuring policy consistency within defined regions of one or more networks. As such, nodes within a policy domain may be coupled virtually, rather than physically. In some embodiments, these network regions may include nodes distributed across one or more Local Area Networks (LANs) or Wide Area Networks (WANs). As a non-limiting, illustrative example, a policy domain may include distinct nodes in different Autonomous Systems. The boundaries delineating a policy domain may also evolve over time.

Embodiments of the invention include hierarchies of policy categories. Policies which govern network processes may be categorized as follows:
Policies that create a group of peers colluding to support a Network Information Base (NIB). Such policies may include policies for establishing peers (“Peer Policies”), which allow the formation of a virtual peer topology for a particular network information base; policies for security validation (“Security Validation Policies”), which govern the rules for security validation observed by the nodes in the Policy Domain; and policies for security delegation (“Security Delegation Policies”) which enable nodes to distinguish valid network information. Non-limiting examples of IP Network Information Bases (NIBs) include Routing Information Bases (RIBs) and Forwarding Information Bases (FIBs).
Policies governing the compression or expansion of network information passed between nodes of a Policy Domain (respectively, “Summarization Policies” and “Expansion Policies”).
Policies that control the flow of information in the network. Examples of such policies include policies which determine which pieces of information are chosen at which priority (“Selection Policies”); policies which determine which information is passed on to what peers (“Distribution Policies”); policies engaged upon the occurrence of distinct events (“Dynamic Distribution Policies”); and policies which govern which policies are distributed within a policy domain (“Policy Distribution Policies”).

Other relevant policy categories and alternative classifications of policy types will be apparent to those skilled in the art.

In some embodiments of the invention, each network policy in a policy domain is classified in exactly one category of a pre-defined hierarchy of policy categories. As a non-limiting, illustrative example, embodiments of the invention include the following policy hierarchy, listed in descending hierarchical order:
2. Peer policies
2. Security validation policies
3. Security delegation policies,
4. Summarization of information policies,
5. Expansion of information policies,
6. Selection policies,
7. Distribution policies,
8. Dynamic Distribution policies
9. Policy Distribution policies

Alternative policy hierarchies and classifications will be apparent to those skilled in the art.

Embodiments of the invention also include numerous algorithms and data structures for preserving consistency amongst the policies supported by the policy domain, and categorized according to the classification hierarchies discussed above. These and other embodiments are described in greater detail infra.

### BRIEF DESCRIPTION OF THE FIGURES

FIG. 1 illustrates a policy domain topology according to embodiments of the invention.

FIG. 2 illustrates a hierarchy of network policies according to embodiments of the invention.

FIGS. 3a and 3b illustrate data structures and algorithms for policy verification according to embodiments of the invention.

FIG. 4 illustrates a policy instance database according to embodiments of the invention.

FIG. 5 illustrates a policy domain topology according to embodiments of the invention.

FIG. 6 illustrates an algorithm for adding policies to preserve consistency according to embodiments of the invention.

FIG. 7 illustrates an example of a policy synchronization schedule according to embodiments of the invention.

### DETAILED DESCRIPTION

1. Introduction

The invention includes mechanisms enabling the establishment, preservation, and dynamic evolution of Policy Domains, which allow distinct network regions to introduce policies in a manner that preserves consistency.

The Policy Domain is a logical construct, and may comprise nodes which are distributed across one or more networks. In some embodiments, each Policy Domain is identified with an identification number.

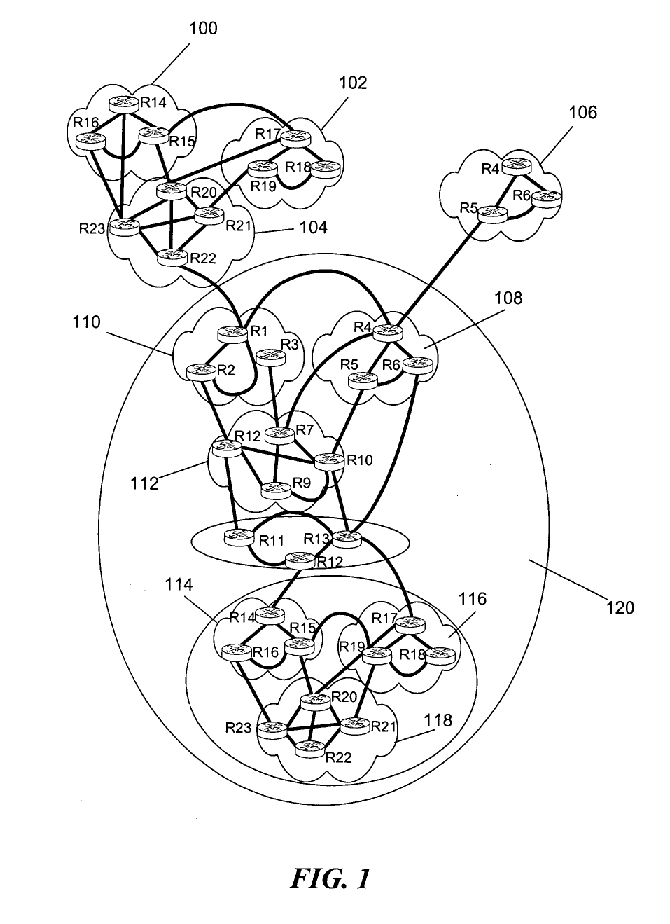

FIG. 1 schematically illustrates a non-limiting embodiment of a policy domain. The figure illustrates multiple interconnected networks 100 102 104 106 108 110 112 114 116. As a non-limiting examples, these networks may comprise distinct autonomous systems or sub-autonomous systems. A policy domain 118 may be superimposed on this topological structure, which may include one or more or the autonomous systems, or only distinct nodes of the plurality of autonomous systems.

In embodiments of the invention, Policy Domains include mechanisms which reduce pre-existing policies into formal policy categories; verify common security policies; enable policy synchronization within the policy domain; and enforce consistency amongst polices governing the policy domain, while enabling new policies to be introduced to the policy domain.

2. Types of Policies

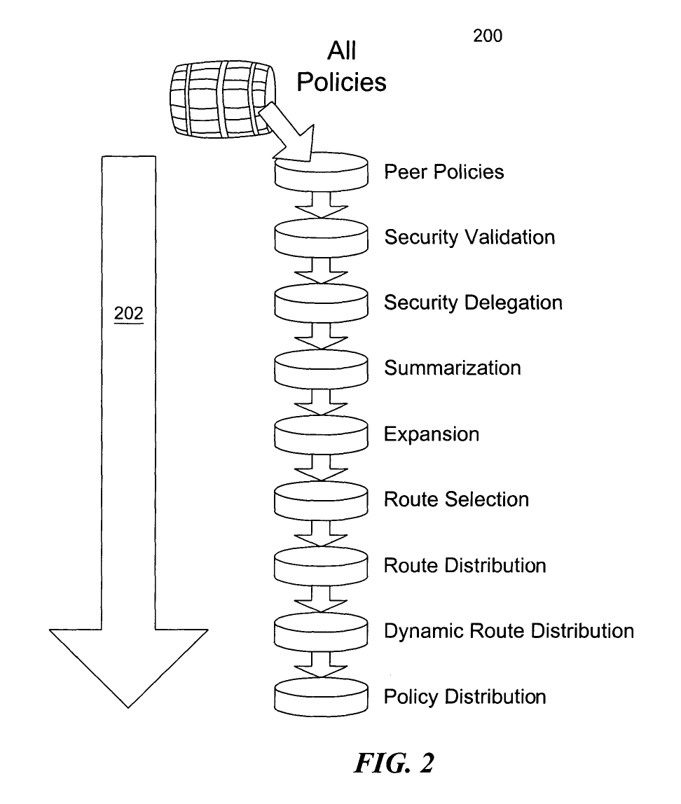

In embodiments of the invention, the types of policies supported by a policy domain may be classified into distinct categories. One illustrative, non-limiting example of such categories is presented in FIG. 2. In some such embodiments, each policy implemented within a policy domain falls into exactly one of the listed categories 200. In embodiments, the categories may also be arranged in a hierarchy; an example of such a hierarchy 202 is presented in FIG. 2.

To illustrate the concept of policy hierarchies, the classifications presented in FIG. 2 are elaborated upon further herein. However, other classification techniques, categories, and hierarchies shall be apparent to those skilled in the art. The policy classifications presented in FIG. 2 may be further categorized as follows:
Policies which aid peers in colluding to support Network information Bases (NIBs). These policies include Peer Policies, Security Validation policies, and Security Delegation policies;
Polices for compressing/expanding information content. This category includes the information summarization policies and information expansion policies; and
Policies that govern the information flow between nodes of the Policy Domain. This category includes route (path) selection policies, route distribution policies, dynamic route distribution policies, and policy distribution policies

The hierarchy 200 presented in FIG. 2 may be instantiated as a filter for categorizing policies. In some embodiments of the invention, policies may be classified by an automated process implementing the filter 200;

alternatively, the filter may comprise a methodology for classification of proposed or existing network policies. To elaborate upon the example of classification hierarchies presented in FIG. 2, the individual categories are elaborated upon infra.

(a). Peer Policies

In embodiments of the invention, a peer policy operating at a node in the policy domain determines the network entities which may exchange information with the respective node. Peer policies include policies governing:
Which peers are reachable, and over which logical links
Which information bases are passed between peers
Security validation policies utilized per Information base, non-limiting examples of which include RIB, FIB, Link State Database (LSDB)
What capabilities each peer in the policy domain supports,
How packets are exchanged

(b). Security Validation Policies

Validation policies for a policy domain may include further sub-categories, such as syntax, context, and attestation; additional sub-categories shall be apparent to those skilled in the art. Policies governing syntax validation enable nodes to determine whether packets conform to correct syntax. A relatively simple example of such validation is confirmation that an IP address in a packet conforms to either IPv4 standards, i.e., 32 bits, or IPv6 standards (128 bits). Other examples include verification that packets received are in conformance with the IETF specifications of the respective protocol. Context validation confirms that information received by a node is within a range specified for the appropriate information base. By way of non-limiting example, in BGP-4 the IPv6 addresses are only valid in the context of the multi-protocol path attribute. Attestation enables confirmation from appropriate sources that information received at a node remains valid after having being transmitted through the network. The authority that attests the validation may be instantiated in different forms: such an authority can be an algorithm, an entity on the network, or other entity as shall be apparent to those skilled in the art. One such entity may comprise a router that uses a public key infrastructure to secure the information. Security validation policies may be implied or explicitly stated in protocol documents, or determined by network policy. Other appropriate sources of security validation policies shall be apparent to those skilled in the art.

(c). Security Delegation Policies

Security delegation policies determine the appropriate authorities to validate syntax, context and attestation information. As elaborated above, these polices may be implicit or explicit in protocol specifications, or otherwise transmitted in the network. An illustrative, non-limiting example of such implied syntax and context is contained in the OSPF v2 specification, which specifies the syntax of the OSPF protocol messages as well as the content inside these messages. An example of an attestation policy is the public key infrastructure, or PKI, which specifies a root authority for passing out certifications, as well as intermediate nodes which can be used for certifications. Other relevant examples shall be apparent to those skilled in the art.

(d). Information Summarization Policies

Information summarization policies enable compression of information passed through a policy domain. Illustrative examples of summarization policies implemented in networks include the use of network subnets by OSPFv2 or proxy aggregation of routes in BGP-4; other such compression techniques are well-known to those skilled in the art. Policies for summarizing information may utilize levels of peer topology, or alternatively, may be based on a flat peer topology.

(e). Information Expansion Policies

Information expansion policies allow compressed or stored information to be elaborated. A simple, illustrative example of an information expansion policy is presented by the expansion of an entry for “Jane Doe” in a Directory Information Base, such as an LDAP directory, to the additional information associated with “Jane Doe”, such as job title, company, street address, telephone number and email address.

(f). Route Selection Policies

Route selection policies determine which pieces of information will be passed onto peers. Route selection policies may enable a given piece of information to traverse single or multiple network pathways. Sub-categories within the route selection polices may include:
Acceptable source lists
Filter lists
Internal preference setting lists
“Dye” lists that add additional information to categorize information (the term “Dye” is used herein in conformance with its well-understood meaning in the context of BGP Communities)
Logic lists combining filter lists and internal preference lists.

In embodiments of the invention, policies filtered through the categorization hierarchy 200 are, upon arrival at the Route Selection Policy, filtered through the categories listed above.

(g). Distribution Policies

Distribution policies govern the information distributed to various peers in the peer topology. Distribution policies may also include sub-categories, such as:
Filter lists to track information exported
Dye lists that add categorization to information transmitted
“Add lists.” i.e, lists that add to information received at a node
Per peer export lists—such lists determine which routes are associated with which dyes, and which additions will be sent to distinct peers
Sink lists—information that is to be consumed by information peer

(h). Dynamic Distribution Policies

Dynamic distribution policies govern actions undertaken upon the occurrence of an event and the receipt or presence of a particular type of information in the network. Events may be synchronous events, i.e., events scheduled at particular times, or asynchronous events triggered by an external source. Such events are elaborated upon further infra.

3. Mechanisms for Supporting and Implementing Policy Domains

Embodiments of the invention include algorithms and data structures for supporting the policies described above. These include algorithms and data structures for security validation, policy synchronization, and for enforcement of consistency amongst policies implemented in a policy domain. Examples of such mechanisms are described further herein.

(a). Mechanisms for Verifying Security Validation Policies

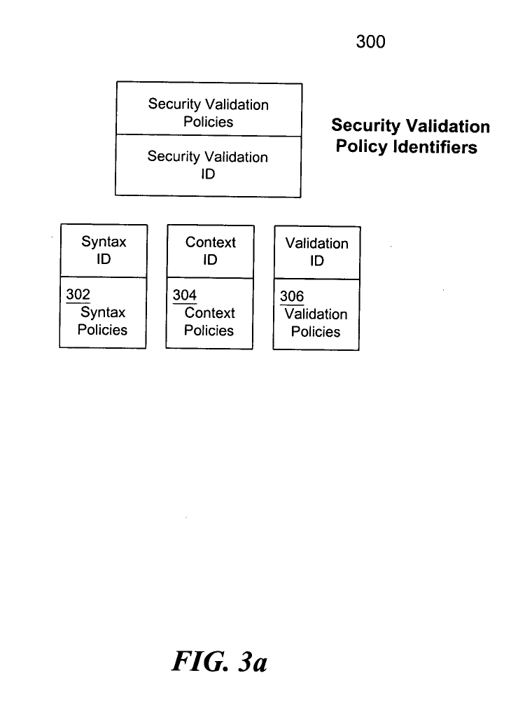

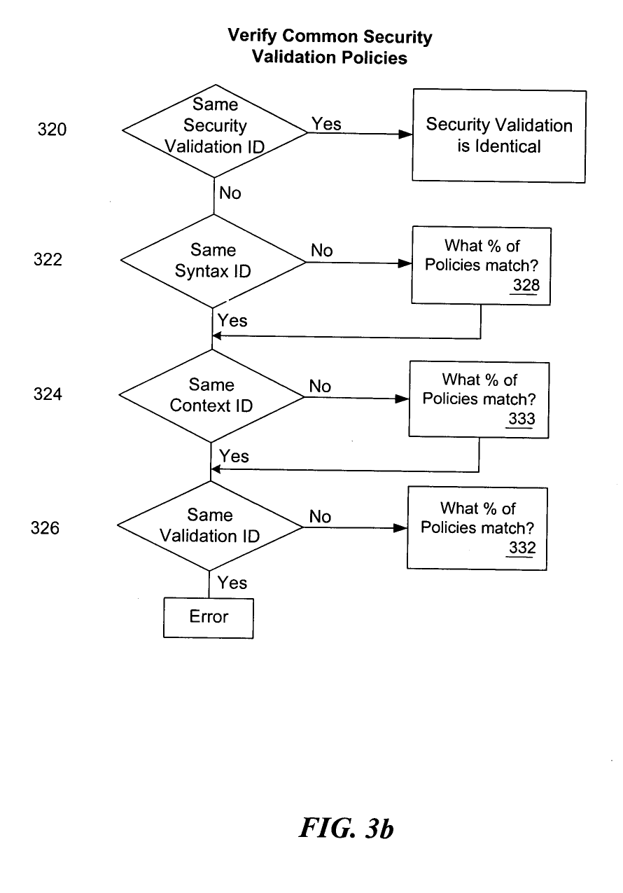

In embodiments of the invention, a Network Information Base (NIB) may include a data structure 300 as illustrated in FIG. 3a, which stores identifiers for Security Validation Policies. As noted above, security validation policies may be further sub-categorized as syntax policies 302, context policies 304, or attestation policies 306, as illustrated further therein. In some such embodiments, nodes in a policy domain may support algorithms for validating Security Validation Policies. One such algorithm is presented in the flowchart of FIG. 3b; other variants and equivalents of security validation algorithms shall be apparent to those skilled in the art.

In embodiments of the invention, the security validation process checks for both exact and probabilistic matches to verify the security validation policies. As a first step, security validation identifiers may be compared between different policies 320 322 324 326. If exact matches are not found, a determination is made of the percentage of sub-categories which match 328 330 332. This information is in turn reported to the processes enforcing policy validation; in embodiments these processes may reside on nodes within the respective policy domain. In alternative embodiments, these processes may be external to the policy domain.

(b). Mechanisms for Supporting Policy Synchronization

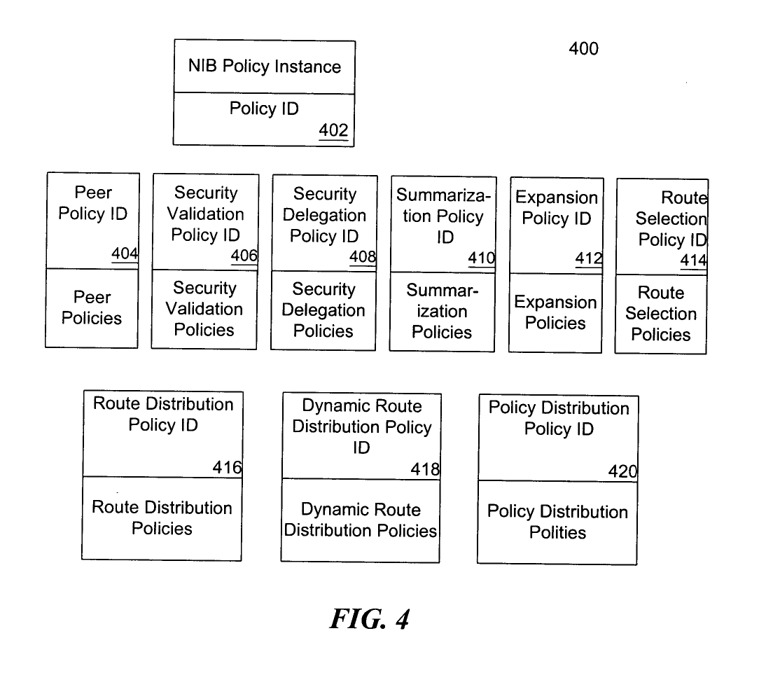

Embodiments of the invention distinguish between different cases of policy inconsistency; specifically, such embodiments include mechanisms for determining whether policies are truly inconsistent, or merely out-of-synch. Accordingly, such embodiments include mechanisms for synchronizing policies in a NIB. One such mechanism for synchronizing policies is illustrated by the policy instance database depicted in FIG. 4. The policy instance database 400 includes identifiers for each of the policies supported by a Network Information Base (NIB). In some embodiments of the invention, these identifiers are unique; furthermore, in some such embodiments, the policy identifiers may be well-ordered and monotonically increasing or decreasing. The example policy instance database illustrated in FIG. 4 includes records for each type of policy classification discussed in Section 2 above; each policy stored in the database 400 includes a unique identifier.

Embodiments of the invention also include algorithms for synchronizing policies supported by a NIB. Such algorithms may reside on nodes within the appropriate policy domain, or on authorized external processors. One such algorithm is presented in pseudo-code as follows: For each node in the Policy Domain for a NIB,
(1) Compare the policy ID of a node's policy instance. If each node's policy instance ID (Policy ID field 402 of the Policy Instance Database) is identical the policy domain's policy, the NIB is synchronized.
(2) If the Policy ID 402 does not match, then compare to the category policy identifications 404-420. If all of the category Ids 404-420 match, then:
   1) select greatest Policy ID
   2) reflood the Policy instance ID with the existing category policy identifiers,
(3) If any categories do not match, then flood the changes for each category that does not match.

Each category with a sub-category uses the same algorithm to determine if the category identifiers are misaligned; however, the sub-category identifiers are the same. If all the sub-category identifiers are the same, then re-flood the category identifier with the list of sub-categories id. If the sub-category identifier is not the same, flood the information for that sub-category.

The algorithm is recursive to the depth of the category breakdown.

Variants, equivalents, and alternative embodiments of the synchronization algorithm will be apparent to those skilled in the art.

(c). Topolocy of Policy Domains and Definition of Consistency

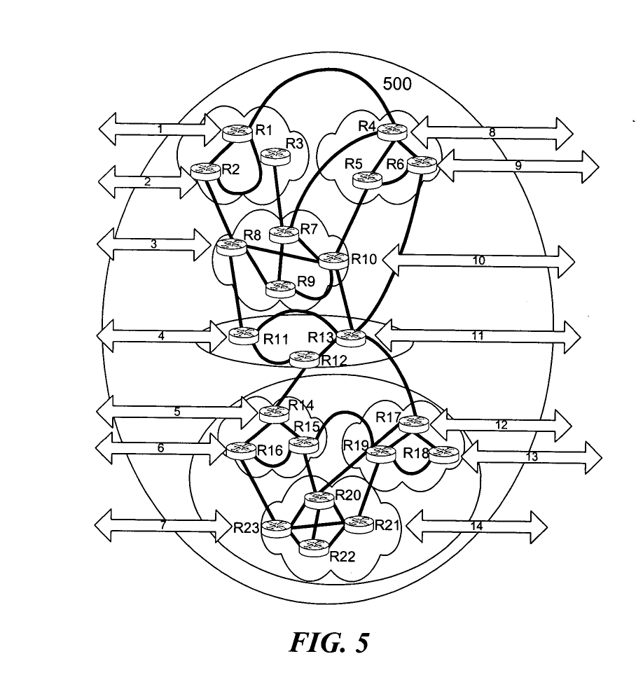

To enforce consistent policy within a Policy Domain, embodiments of the invention include topologies for ensuring such consistency. FIG. 5 depicts an illustrative, non-limiting example of such a topology. A policy domain 500 includes multiple peers R1-R22. These peers collude to support a common Network Information Base (NIB). Additionally, each peer, or node, supports an identical security policy for authenticating policy information, by virtue of a common security authority. The Policy Domain includes entrance/exit peers R1 R2 R4 R6 R8 R10 R11 R14 R16 R17 R18 R21 R23, and the links interconnecting the nodes may be virtual, rather than physical. These entrance/exit peers delineate a boundary, or edge, of the policy domain.

Policy Consistency can be defined with reference to the topology of the Policy Domain. A Policy Domain supports consistent policies if the following conditions are met:
If each policy in the policy database is broadcast unmodified to each node in the policy domain (e.g., each policy is set to ‘send all, receive all, modify none’)
Then
The design of the network ensures that all route selection policies can be aggregated to the edge of the policy domain and route selection can run at the edge of the policy domain

The “Then” clause in the definition above may be restated more specifically by reference to the example topology as follows:
For every entrance peer Peerᵢ and exit peer Peerⱼ, and for every path Pathₖ in the Policy Domain coupling Peerᵢ and Peerⱼ, application of the route selection policy on each Pathₖ is identical.

(d). Consistency Enforcement Algorithms

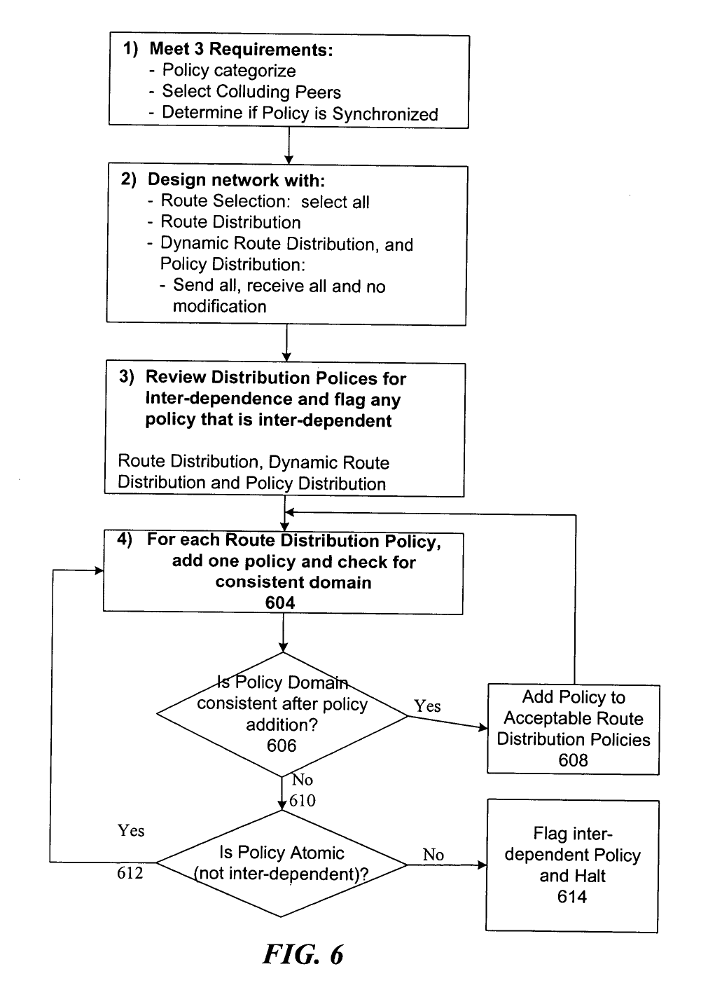

Embodiments of the invention include methodologies and algorithms for ensuring that consistency is maintained between policies in a policy domain. Examples of such methods and algorithms are illustrated in the flowchart of FIG. 6 In some such embodiments, the algorithms operate after the following conditions have been met:
The polices have been sorted policies into the category hierarchies, as elaborated in Section 2 above.
The peers colluding to support the NIB have been selected, as illustrated in section (c) above,
Policy has been synchronized on all peers, as presented in section 3(b) above

Upon securing the steps above, the consistency preservation techniques proceed as follows:
The route distribution policy, dynamic route distribution policies, and policy distribution policies are examined to determine whether these policies include inter-dependencies, or can be applied atomically. Interdependent policies are flagged 602.
For each route distribution policy, add one policy 604 and
   Check that policy domain is remains consistent 606 for all pathways Pathₖ between all entrance peers Peerᵢ and exit peers Peerⱼ
   If addition of the new policy allows the policy domain to remain consistent, then add this policy to the set of acceptable policies for route distribution 608.
   If the new policy does not allow the policy domain to be consistent 610, then
      1. Do not add the new policy to the set of acceptable
      2. Continue if the policy is atomic 612.
      3. Discontinue policy processing if the policy is flagged as inter-dependent, and exit the enforcement algorithm 614.

A non-limiting example of an inter-dependent set of policies is illustrated by BGP, which allows the addition of a community to “dye” routes a color; policies may subsequently be written on the color, thereby entailing interdependency of the routes in the color.

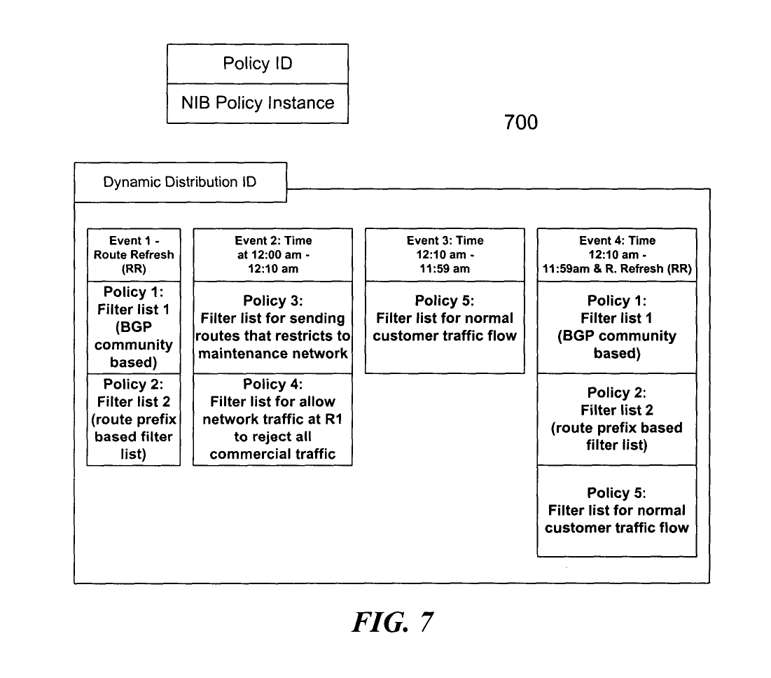

Embodiments of the invention also include algorithms for preserving consistency of dynamic route distribution policies, which proceed as follows:
For each dynamic route distribution policy, sort the policies by events. An example of the results of such a sort 700 is depicted in FIG. 7.
Evaluate each event to determine if the events can overlap. If the any event can overlap, create an additional event that combines all overlapping events and points to all dynamic policies that might interact at one time.
For each policy event, iterate on all policies impacted by the event to ensure that the policies enacted per event remain consistent:, i.e.,
   Check the policy domain is consistent for all pathways between all information entrance peers and information exit peers when the dynamic policy is enacted.
   If this policy still allows the policy domain to be consistent, then add this policy to the acceptable policies for dynamic distribution of routes for this event.
   If this policy does not allow the policy domain to be consistent, then
      Do not add the policy to the acceptable policies
      Continue if the policy is atomic.
      Discontinue policy processing if the policy is flagged as inter-dependent, and exit the enforcement algorithm.

Embodiments of the Invention include similar algorithms for preserving consistency amongst summarization and expansion policies, and for policy distribution policies.

4. Conclusion

From the foregoing, it will be appreciated that specific embodiments of the invention have been described herein for purposes of illustration, but that various modifications may be made without deviating from the spirit and scope of the invention. In particular, many equivalent algorithms may be used, and the examples presented here are for illustrative purposes only. Accordingly, the invention is not limited except as by the appended claims.

1. A system for synchronizing a plurality of network policies amongst a plurality of network nodes, the plurality of network policies operative of the plurality of nodes to regulate data traffic through the plurality of nodes, the system comprising:
an ordered plurality of classifications of the plurality of network policies, the ordered plurality of classifications including
a first one or more classifications identifying policies enabling collusion between the plurality of network nodes to support a common database of network policies,
a second one or more classifications identifying policies for compressing or expanding information passed amongst the plurality of nodes,
a third one or more classifications including policies for route distribution and selection in the plurality of nodes;
a plurality of local policy databases, each of the plurality of local policy databases residing on a respective node in the plurality of nodes, each of the local policy databases further including a plurality of policy instances operative on the respective node; and
a plurality of synchronization processes resident on the plurality of nodes, the plurality of synchronization processes operative to minimize a convergence time between the plurality of local databases and the common database of network policies, wherein the plurality of synchronization processes are further operative to map network policies received at the respective node to the ordered plurality of classifications.

2. The system of claim 1, wherein the plurality of nodes are distributed across one or more wide area networks.

3. The system of claim 1, wherein the plurality of nodes are at least partially packet-switched.

4. The system of claim 1, wherein the plurality of nodes are at least partially cell-switched.

5. The system of claim 1, wherein the plurality of nodes at least partially overlap one or more autonomous systems.

6. The system of claim 1, wherein the plurality of nodes at least partially overlap two or more autonomous systems.

7. The system of claim 1, wherein the plurality of nodes communicate at least partially via an Interior Gateway Protocol.

8. The system of claim 1, wherein the plurality of nodes communicate at least partially via an Exterior Gateway Protocol.

9. The system of claim 1, wherein the plurality of nodes communicate at least partially via Border Gateway Protocol (BGP)

10. The system of claim 1, wherein the first one or more classifications further identifies policies for validating network information exchanged amongst the plurality of nodes.

11. The system of claim 1, wherein the first one or more classifications further identifies policies for validating information exchanged amongst the plurality of nodes for security.

12. The system of claim 11, wherein the first one or more classifications further identifies policies for validating information exchanged amongst the plurality of nodes for conformance to syntax.

13. The system of claim 11, wherein the first one or more classifications further identifies policies for validating information exchanged amongst the plurality of nodes for appropriate syntax.

14. The system of claim 11, wherein the first one or more classifications further identifies policies for ensuring that information received at the respective node has arrived intact from a trusted source.

15. The system of claim 1, wherein the first one or more classifications further identifies policies for validating security of information exchanged amongst the plurality of nodes.

16. The system of claim 1, further comprising:
a plurality of consistency enforcement processes resident on the plurality of nodes, the plurality of consistent enforcement processes ensuring internal consistency of the plurality of local databases.

17. The system of claim 1, wherein each of the plurality of nodes includes one or more routers.

18. In an inter-network including a plurality of interconnected communications nodes, a method of colluding between the plurality of nodes, the method comprising:
at a first node in the plurality of nodes, receiving a network policy instance from a second node in the plurality of nodes, the network policy instance regulating processing of data traversing the inter-network;
determining consistency of the network policy instance with a local policy database resident in the first node, the local policy database regulating network processing in the first node, determining consistency of the network policy instance further including identifying the network policy instance in a hierarchy of network policies to determine a rank for the network policy instance; and
if and only if the network policy is consistent with the local policy database, adding the network policy to the local policy database.

19. The method of claim 18, wherein the plurality of network nodes are distributed across one or more autonomous systems.

20. The method of claim 18, wherein the plurality of network nodes are distributed across two or more autonomous systems.

21. The method of claim 18, wherein the plurality of network nodes are at least partially packet-switched.

22. The method of claim 18 wherein the plurality of network nodes are at least partially cell-based.

23. The method of claim 18, wherein the inter-network includes one or more Exterior Gateway Protocols.

24. The method of claim 18, wherein the inter-network includes one or more interior gateway protocols.

25. The method of claim 18, wherein the inter-network employs Border Gateway Protocol.

26. The method of claim 18, wherein the network policy instance specifies which of the plurality of nodes are reachable from the first node.

27. The method of claim 18, wherein the network policy instance specifies certificate authorities for authenticating information passed between the plurality of nodes.

28. The method of claim 18, wherein the network policy instance specifies syntax rules for packets received by the first node.

29. The method of claim 18, wherein the network policy instance specifies attestation policies for the first node.

30. The method of claim 29, wherein the attestation policies are based on IPSec.

31. The method of claim 29, wherein the attestation policies are based on MD-5.

32. The method of claim 29, wherein the attestation policies are based on Public Key Infrastructure.

33. The method of claim 18, wherein the network policy instance specifies policies for compressing information forwarded in the plurality of nodes.

34. The method of claim 18, wherein the network policy instance specifies policies for expanding information traversing the plurality of nodes.

35. The method of claim 18, wherein the network policy instance specifies route selection policies.

36. The method of claim 18, wherein the network policy instance specifies route distribution policies.

37. The method of claim 36, wherein the route distribution policies may be time-based.

38. The method of claim 37, wherein the route distribution policies may be event-based.

39. The method of claim 18, wherein the network policy instance includes peer policies, the peer policies determining at least one of a network information base supported by the peer and one or more protocol functions supported by the peer.
